(19) United States
(12) Patent Application Publication
(10) Pub. No.: US 2014/0311475 A1
(43) Pub. Date: Oct. 23, 2014

(54) HIGH PERFORMANCE OUTDOOR PORTABLE COOKING SYSTEM

(71) Applicant: Johnson Outdoors Inc., Racine, WI (US)

(72) Inventors: W. Perry Dowst, Weare, NH (US); Adam E. Wilcox, Candia, NH (US); Spencer O. Hartfeld, Manchester, NH (US); Michael E. Hebert, JR., Milford, NH (US)

(73) Assignee: Johnson Outdoors Inc., Racine, WI (US)

(21) Appl. No.: 14/259,618

(22) Filed: Apr. 23, 2014

Related U.S. Application Data
(60) Provisional application No. 61/815,165, filed on Apr. 23, 2013.

(51) Int. Cl. A47J 37/07

(52) U.S. Cl. CPC A47J 37/0763
USPC 126/25 R; 126/39 E

(57) ABSTRACT

A portable cooking system is provided that includes a burner base, a cooking vessel and a canister. The canister may be oriented in an inverted arrangement. The burner may be oriented vertically above the canister. The system may include an evaporator feed tube that includes a heating section that preheats the fuel prior to the fuel being combusted. Further, the system may include a valve/regulator assembly for reducing the pressure of the fuel prior to the fuel flowing through the evaporator tube or being preheated. The system may be used with butane LPG.

### CROSS-REFERENCE TO RELATED PATENT APPLICATIONS

This patent application claims the benefit of U.S. Provisional Patent Application No. 61/815,165, filed Apr. 23, 2013, the entire teachings and disclosure of which are incorporated herein by reference thereto.

### FIELD OF THE INVENTION

This invention generally relates to portable cooking systems and particularly portable cooking systems for use in cold temperatures.

### BACKGROUND OF THE INVENTION

Outdoors enthusiasts such as backpackers, mountain climbers, or expeditionists are often in remote locations for extended periods of time in harsh weather conditions, including cold temperatures, with only snow or ice as a source of hydration. In these circumstances, they rely for survival on their cooking equipment for both nutrition and hydration, melting available snow and using it to produce water as well as to cook. Therefore, a design offering speed, ease of use and reliability (including ignition), and heating efficiency over the full range of temperature and weather conditions is of high value.

Current products and designs tend to offer either high power on the one hand (namely, liquid fuel stoves), or ease-of-use and efficiency on the other (namely, LPG fuel stoves and systems). While liquid fuel stoves offer high output over a wide range of temperature conditions, they are generally difficult to light and are prone to sooting and clogging in fuel passageways, and so require expertise and maintenance in often difficult conditions. LPG fuel type products generally include automatic ignition and clean burning, however, suffer from reduced heat output with falling temperature and often require special care to perform in typical conditions that these end users experience.

There have been advances in liquid fuel designs to improve ignition and reliability, as there have been advances in LPG type designs to maintain heat output in colder temperatures. However, the underlying limitations of each remain, forcing the end user to choose fundamentally between power and ease-of-use/reliability.

### BRIEF SUMMARY OF THE INVENTION

An embodiment of the invention offers the very highest level of heating power available in a portable cooking product design, while offering the very highest levels of convenience and reliability available in any current portable cooking product design.

An object of embodiments of the invention is to provide a higher performing outdoor portable cooking system than is currently available. An embodiment of the invention combines the consistency, control, and ease-of-use provided by LPG (liquid petroleum gas) fuel regulated stove products with the high heat output in cold weather conditions provided by liquid fuel (e.g., gasoline or kerosene) stove products.

In one embodiment, a liquid-to-gas phase change regulator, used in conjunction with LPG fuel, and additionally with an evaporator feed line and/or a heat transfer structure equipped cooking vessel is provided to create a constant, high heat output cooking system with superior ease-of-use.

In a particular embodiment, the canister of the system is mounted in an inverted state. In another embodiment, the fuel is pre-heated prior to being combusted at a burner of the system. In another embodiment, the fuel first passes through a valve/regulator assembly to reduce the pressure of the fuel prior to passing through the evaporator feed tube or being preheated.

In another embodiment, an evaporator feed tube is provided between the phase change regulator and the burner. In a more particular embodiment, a section of the evaporator feed tube is heated by the exhaust gases provided by the burner to preheat the fuel prior to being combusted. This heating section of the evaporator feed tube helps maintain or improve the phase change of the liquid fuel to provide wholly gaseous fuel prior to being combusted.

In one embodiment, the evaporator feed tube further includes a filler positioned within the evaporator feed tube.

In one embodiment, a regulator assembly includes: a regulator housing that is secured to a regulator body defining an internal cavity therebetween; a disc spring assembly including a disc spring pack including four disc springs each having a generally conical profile; a diaphragm secured within the internal cavity adjacent the disc spring cup; and a poppet assembly located on an opposite side of the diaphragm as the disc spring piston.

In one embodiment, the disc spring assembly further includes a disc spring piston and the poppet assembly includes: a poppet hat, a poppet body, a poppet stem; a poppet spring, and a poppet O-ring carried on the poppet stem.

In one embodiment, the disc spring piston, the disc spring cup, poppet hat, poppet body, and poppet stem are nickel-plated brass.

In one embodiment, the disc springs are grouped in pairs with two disc springs aligned and interfitted with one another and two other disc springs aligned and interfitted with one another. The two sets of disc springs are aligned in a back-to-back arrangement such that the sets of disc springs point axially away from one another.

In one embodiment, the regulator assembly is configured to reduce the pressure of liquid fuel to approximately 10 psi above atmospheric pressure.

In one embodiment, the portable cooking system further includes an annular wind shield releasably mounted to and surrounding, at least in part, the cooking vessel. The annular wind shield has a top edge that is vertically above the burner and a bottom edge that is vertically below the burner.

In one embodiment, the portable cooking system further includes an annular wind shield releasably mounted to and surrounding, at least in part, the cooking vessel. The annular wind shield has a top edge that is vertically above the bottom of the cooking vessel and a bottom edge that is vertically below the bottom of the cooking vessel.

In one embodiment, the canister connection portion faces the burner and is configured such that when a canister is mounted to the canister connection portion the canister is inverted with an outlet of the canister vertically below a bottom wall of the canister.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a side perspective illustration of a portable cooking system according to an embodiment of the present invention;

FIG. 2 is a cross-sectional illustration of the portable cooking system of FIG. 1;

FIGS. 3-5 illustrate the primary components of the portable cooking system of FIG. 1 removed from one another;

FIG. 6 is a partial illustration of the canister of FIG. 1 mounted to the valve/regulator assembly and burner of the portable cooking system of FIG. 1;

FIG. 7 is an enlarged cross-sectional illustration of the valve assembly of the portable cooking system illustrating the needle valve;

FIG. 8 is an enlarge cross-sectional illustration of the pressure regulator assembly of the portable cooking system;

FIG. 9 is an enlarged cross-sectional illustration of the evaporator feed tube extending into the pressure regulator assembly;

FIG. 10 illustrates the fuel flow through the evaporator feed tube through a pre-heating section thereof;

FIG. 11 is cross-sectional illustration of the burner assembly of the portable cooking system showing the fuel/air flow through the burner;

FIG. 12 is a cross-sectional illustration similar to FIG. 11 showing the exhaust flow through the heat transfer structure of the cooking vessel;

FIG. 13 is a performance graph of the portable cooking system compared to other systems;

FIG. 14 illustrates a further embodiment of a portable cooking system;

FIG. 15 is a simplified and enlarged illustration of the portable cooking system of FIG. 14;

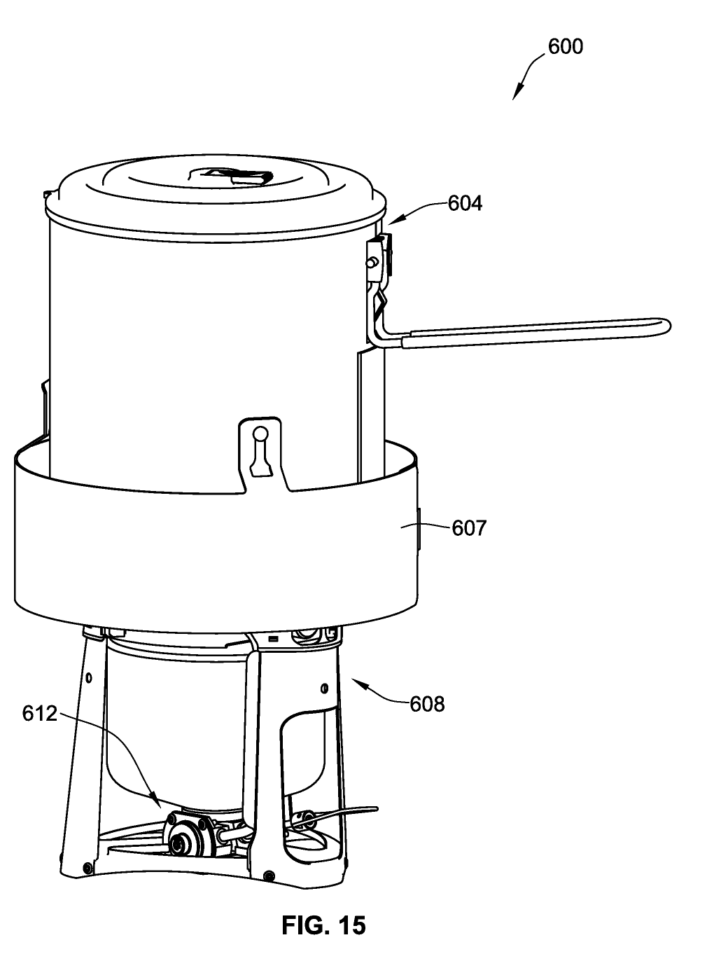

FIG. 16 is a cross-sectional illustration of the portable cooking system of FIG. 14;

FIG. 17 is an exploded illustration of a valve/regulator assembly according to an embodiment of the invention; and

FIG. 18 is a partial cross-sectional illustration of the valve/regulator assembly of FIG. 17.

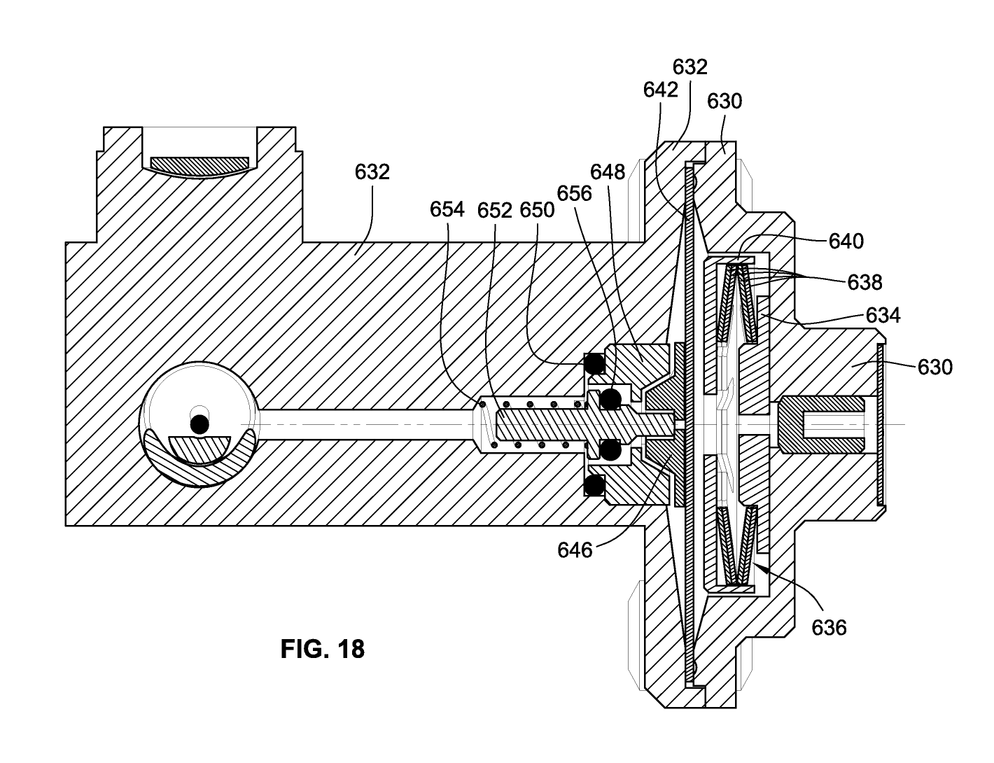

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

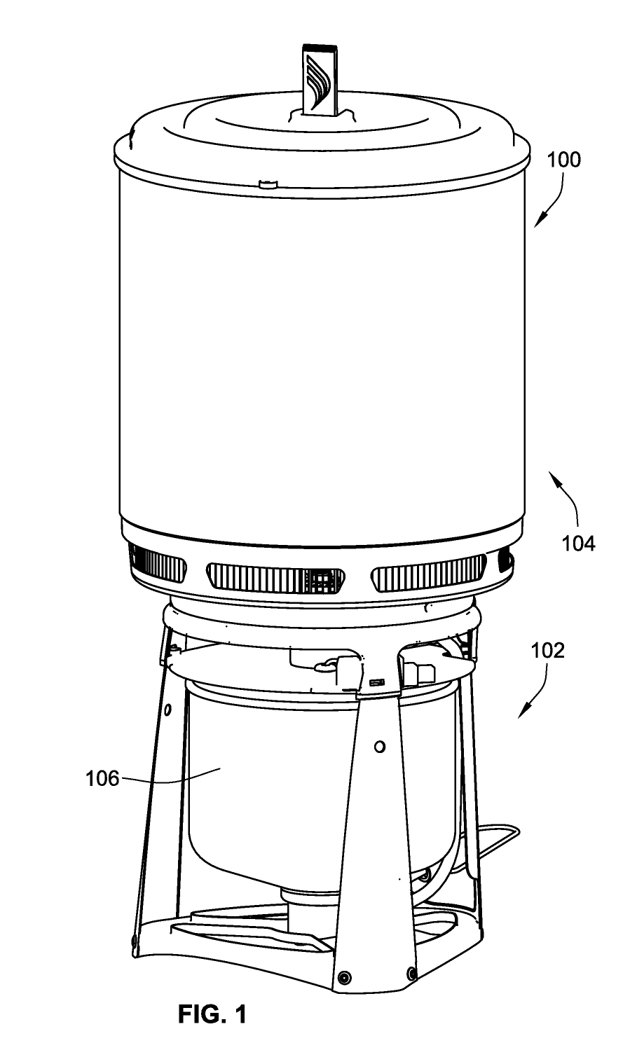

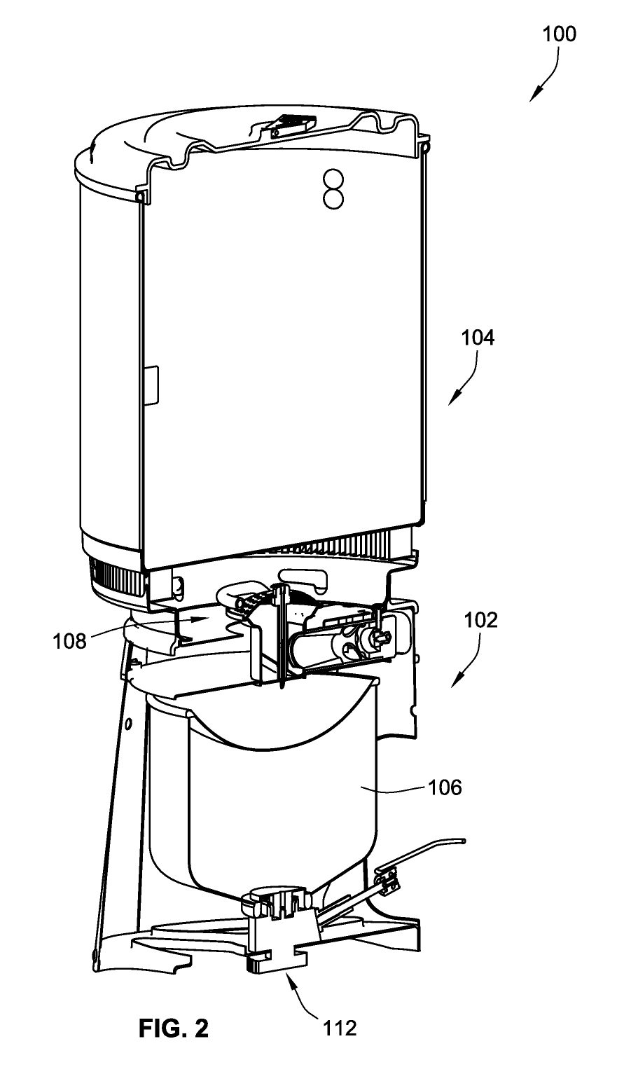

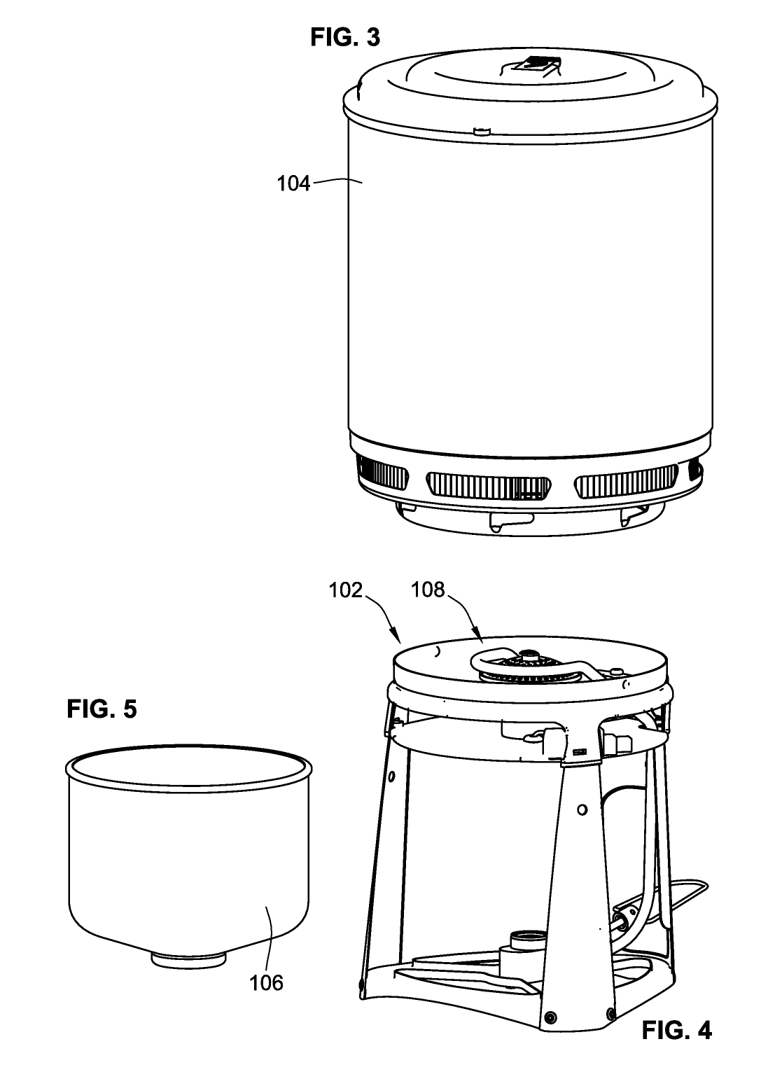

FIG. 1 illustrates a portable cooking system 100 according to an embodiment of the present invention. The portable cooking system 100 includes three elements: a burner base 102 a cooking vessel 104, and a butane LPG fuel canister 106. In one embodiment, the portable cooking system 100 and particularly burner base is configured to support the butane LPG fuel canister in an inverted orientation (i.e. open end vertically downward relative to gravity). Here, the fuel exits the canister 106 in a direction extending generally vertically away from the cooking vessel 104 and a burner portion 108 of the burner base 102. (See cross-sectional illustration of FIG. 2). FIGS. 3-5 illustrate the three primary components separated from one another.

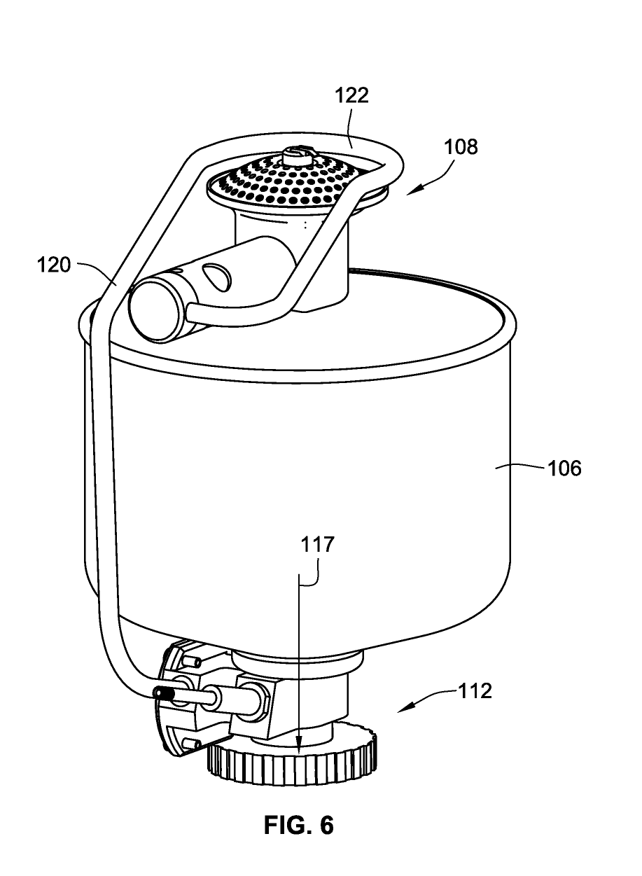

Within the burner base 102, a valve/regulator assembly 112 receives liquid LPG fuel from the inverted canister 106, as illustrated in FIG. 6. The pressurized LPG fuel is in liquid state as it enters the valve/regulator assembly 112. The burner base 102 includes a canister connection structure upon which the canister 106 is mounted in an inverted orientation. Fuel exits the canister 106 and into the rest of the burner base through the canister connection structure.

Because the canister 106 is inverted, the liquid fuel will reside in the lowest portion of the inverted fuel canister 106 due to gravity proximate the fuel canister valve 114 where fuel will exit the canister 106. Customarily, the canister 106 is not inverted and the fuel settles to the bottom of the canister 106 at the opposite side of the canister 106 from the fuel canister valve 114.

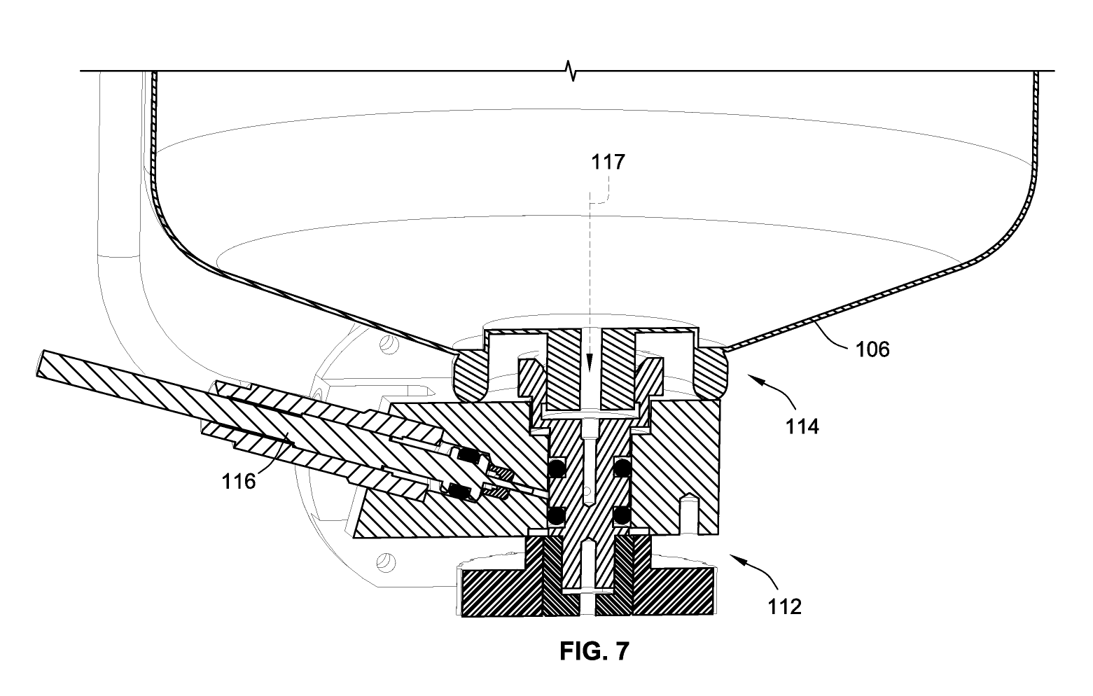

With reference to FIG. 7, the valve/regulator assembly 112 controls the LPG fuel 117 flow by a precision needle valve 116. The canister construction structure may be considered to be part of the valve/regulator assembly 112. It may have threads or other mechanisms for securing the canister 106 to the burner base 102.

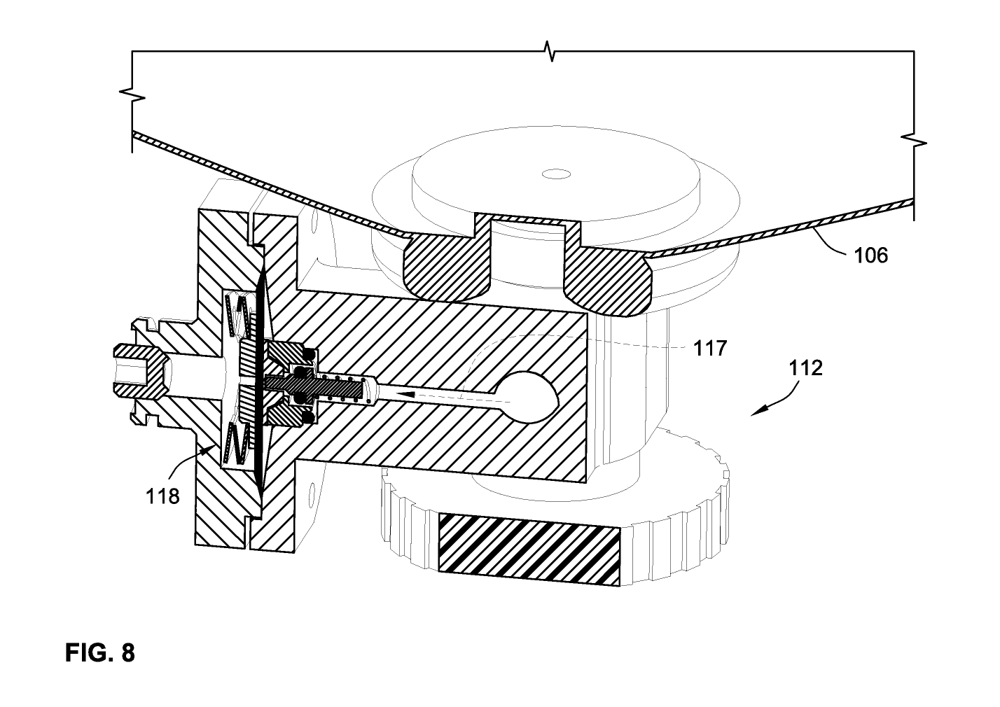

From there, the liquid LPG fuel enters the pressure regulator assembly 118, which is a portion of the valve/regulator assembly 112. The pressure regulator assembly, illustrated in FIG. 8, includes a combination of springs and a rubber type (or other material) diaphragm to reduce the pressure of the LPG fuel exiting the pressure regulator assembly 118.

It is within the pressure regulator assembly 118 that under typical operation conditions (20-70 degrees Fahrenheit) that the majority of the LPG fuel 117 changes its state from liquid to gas, due to the reduction in pressure within the pressure regulator assembly 118.

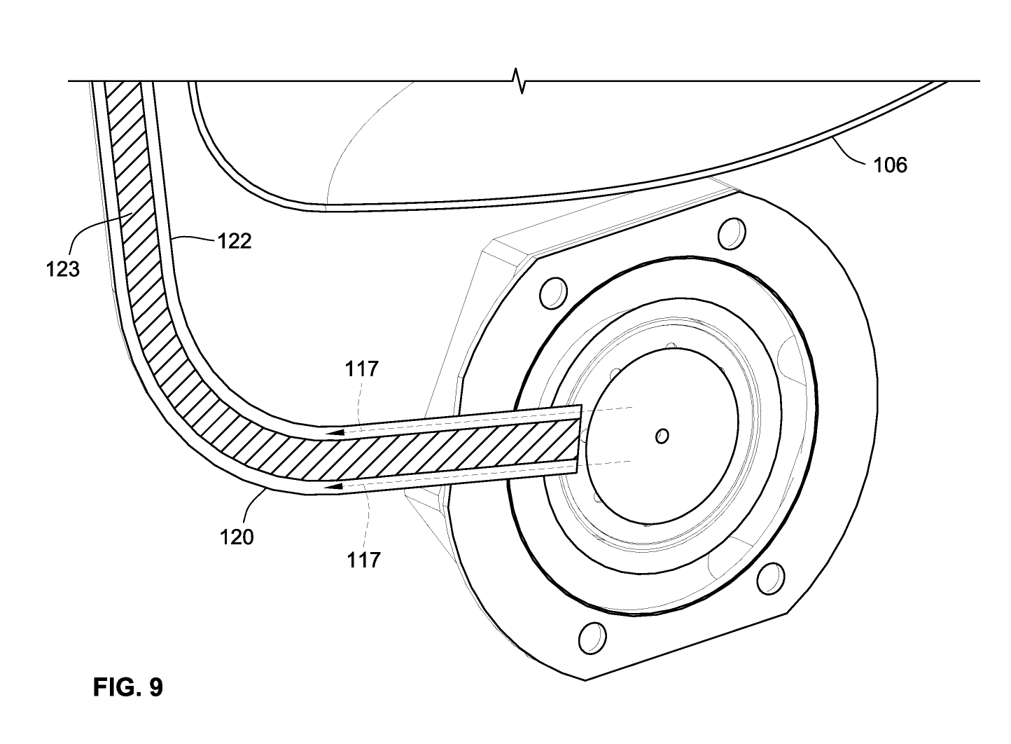

From there, the LPG fuel, in essentially 100% gas state, exits the pressure regulator assembly 118, and enters an evaporator feed tube 120, as illustrated in FIG. 9.

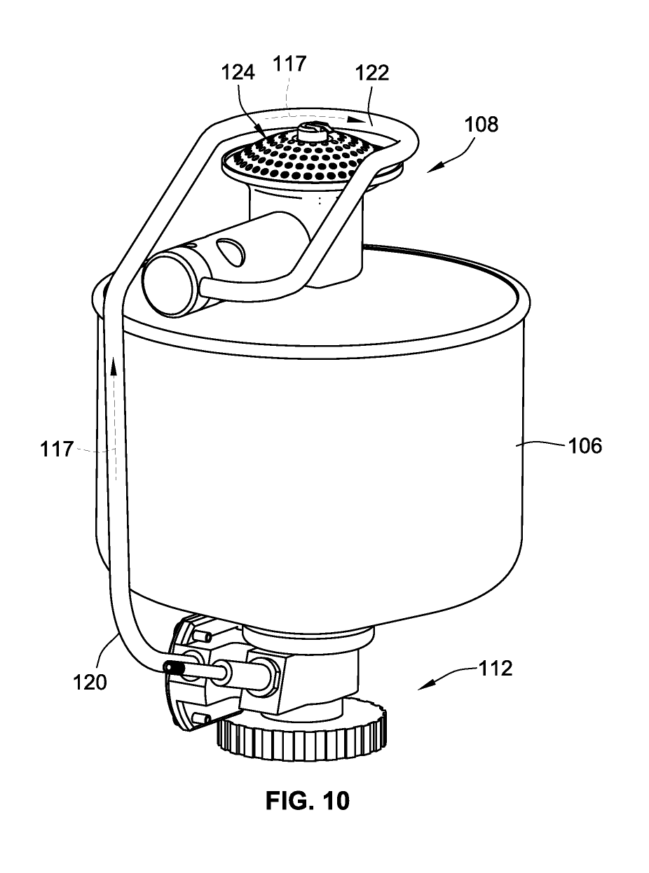

With reference to FIG. 10, the LPG fuel, in essentially 100% gas state, travels upward within the evaporator feed tube 120. The evaporator feed tube 120 includes a heated section 122 that passes in close proximity to a gas burner exit 124 formed in the burner portion 108. The exhaust gasses exiting the burner pass across he heated section 122. As the fuel 117 passes through the heated section 122 of evaporator feed tube 120, the fuel is preheated so that any remaining liquid fuel component within the fuel stream is wholly converted to a gaseous state.

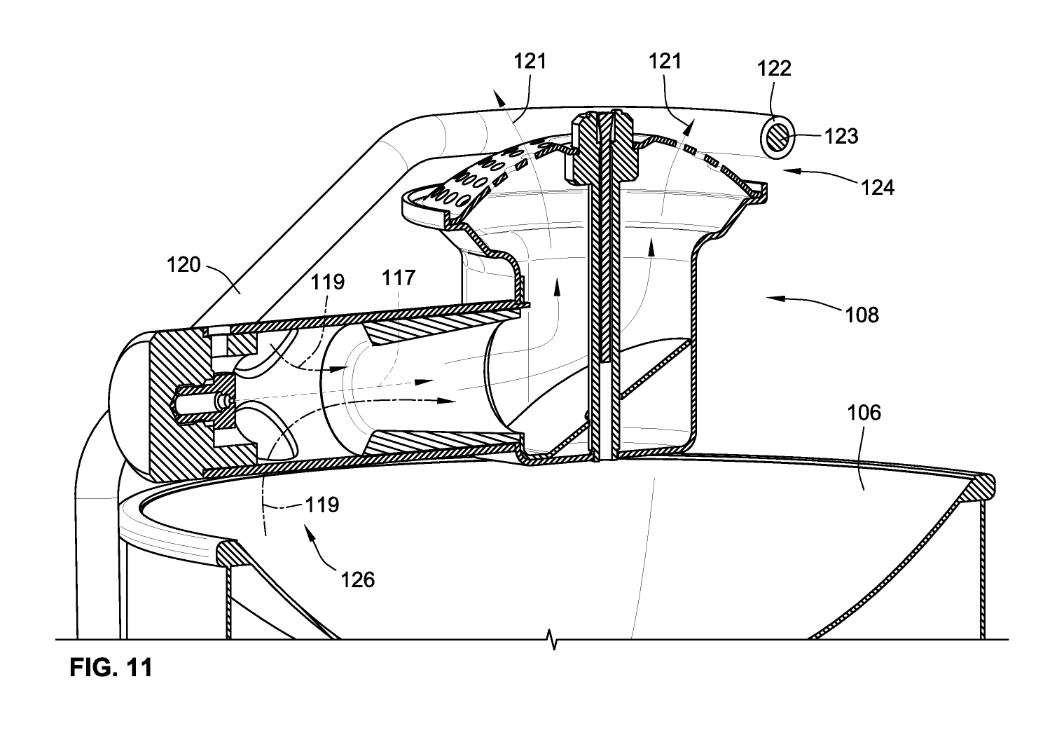

With reference to FIG. 11, after passing through the heated section 122 of the evaporator tube 120, the now fully 100% gaseous LPG fuel 117 enters the orifice jet 126, exiting into the gas burner portion 108, where along with entrained air 119, it is combusted upwardly through the burner exit 124, illustrated as arrow 121.

The evaporator tube 120 includes a cable 123 positioned therein to act as a filler. The cable 123 forces the fuel that passes through the evaporator tube 120, and particularly through the heated section 122 toward the outer wall of the evaporator tube 120 to promote heat transfer to the fuel and improve the preheating effect of the fuel.

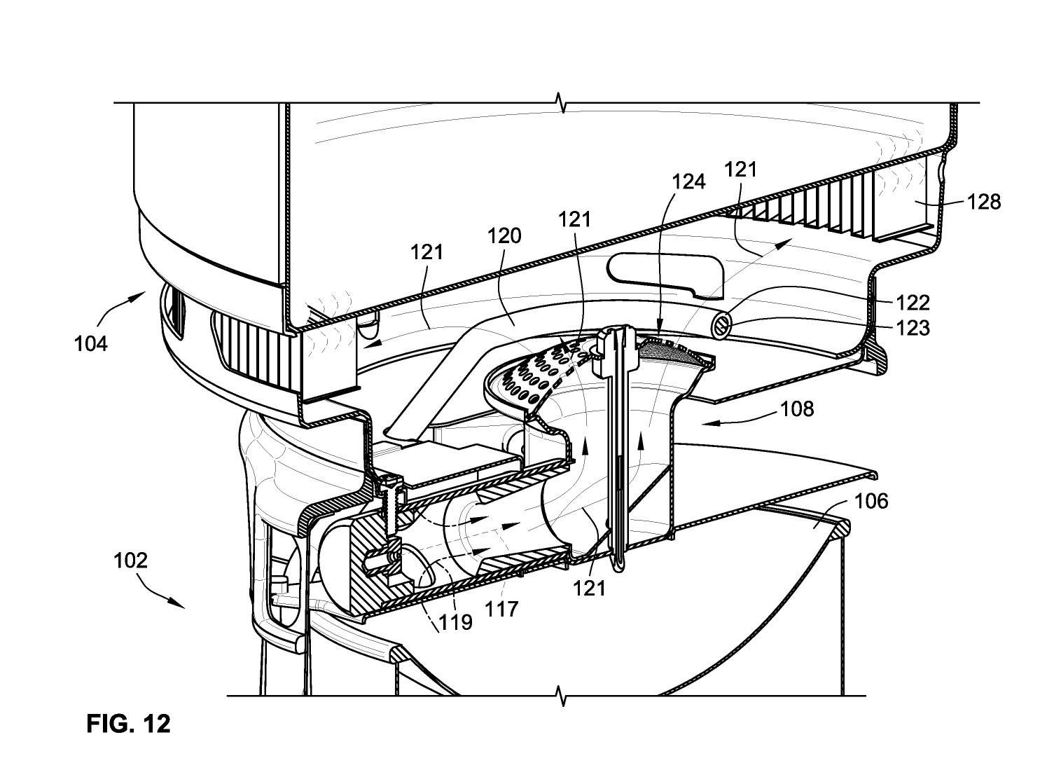

With reference to FIG. 12, from there, the combusted gas/air exhaust enters the cooking vessel heat transfer structure 128, and exits in a radially outward direction. As the exhaust exits outwardly approximately 75% of its heat energy is transferred through the heat transfer structure 128 to the contents of the cooking vessel 104. Some of the heat energy is also transferred to the heated section 122 of the evaporator feed tube 120.

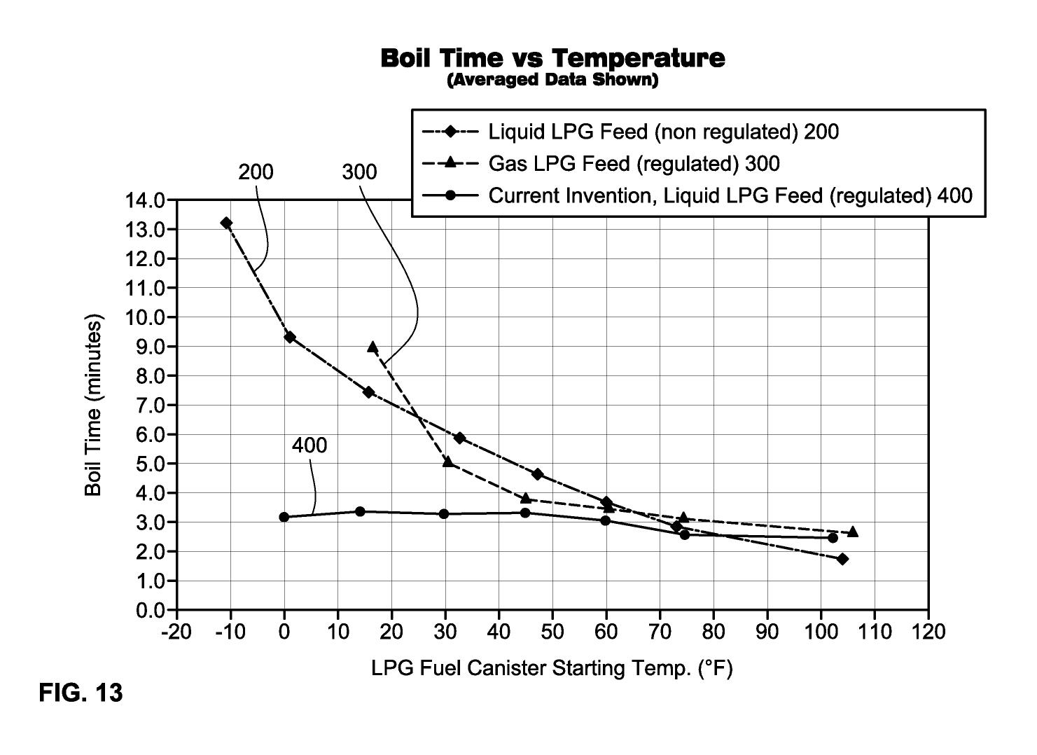

FIG. 13 is a graph presenting data generated from a portable cooking system 100 according to an embodiment of the present invention as disclosed compared to two conventional LPG Fuel cooking system products under similar conditions.

All data collected shows average time to boil one liter of water in the laboratory for fuel canister temperatures between roughly 0 and 100 degrees Fahrenheit, under otherwise identical conditions. The boil times recorded for all products and designs varies between around 2 minutes to over 12 minutes, depending on the starting LPG fuel canister temperature.

The conventional Liquid LPG Un-regulated Feed product (diamond trace 200 beginning at 13 minutes and ending at less than 2 minutes) lacks a pressure regulator in which liquid fuel is converted to a gaseous state before entering the fuel evaporator feed tube. The performance of this design displays a nearly exponentially increasing time to boil with respect to decreasing starting canister temperature, a distinct negative performance characteristic for cold temperature use.

The conventional Gas LPG Regulated Feed product (triangle trace 300 beginning at 9 minutes and ending at just less than 3 minutes) includes a pressure regulator. However, fuel enters the regulator in a gaseous state before burner to be combusted. This design does not incorporate an evaporator tube. The performance of this design displays a nearly constant time to boil with respect to decreasing starting canister temperature above about 40 degrees Fahrenheit. The time to boil increases dramatically at about 40 degrees Fahrenheit until the product stops functioning at about 15 degrees Fahrenheit canister temperature. Since many users of this product expect the product to perform in this low temperature range, this also represents a distinct negative performance characteristic for cold temperature use.

In contrast, the performance of the portable cooking system 100 according to an embodiment of the present invention (circle trace 400 beginning at just over 3 minutes and ending at about 2.5 minutes) displays a nearly constant fast boil time from a very low temperature range to typical warm ambient conditions. This performance represents a distinct strong advantage for end users cooking or melting snow in cold environments.

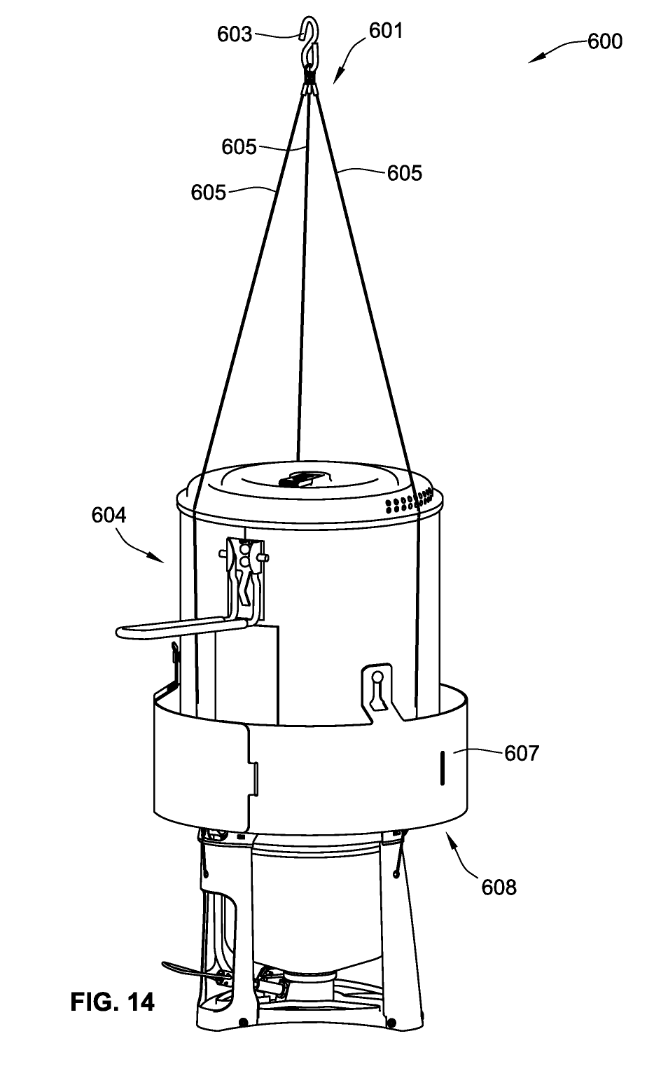

FIG. 14 illustrates a further embodiment of a portable cooking system 600 according to a further embodiment of the invention. The portable cooking system 600 is similar to portable cooking system 100 and includes many of the same features. The features of portable cooking system 600 may also be incorporated into portable cooking system 100 previously described.

Portable cooking system 600 includes a hanging hook assembly 601 for hanging the portable cooking system 600. The hanging hook assembly 601 includes hook 603 and cables 605 connected to the hook 603 at one end. The opposite ends of the cables 605 are operably connected to the rest of the portable cooking system 600.

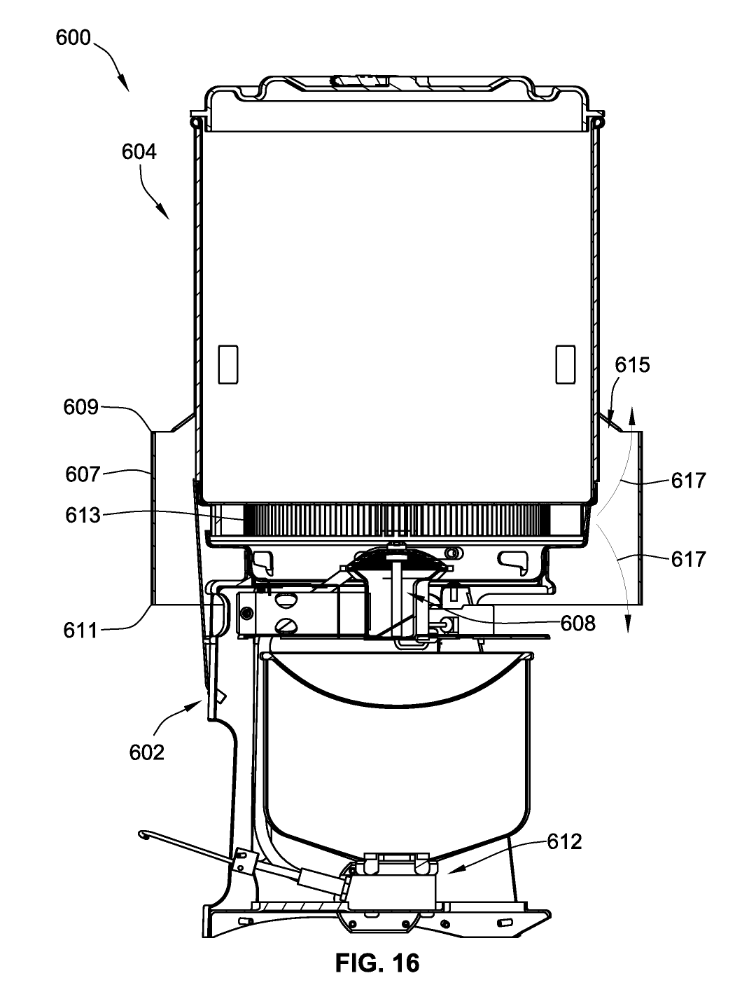

The portable cooking system 600 also includes a wind shield 607 that releasably connects to the cooking vessel 604. The wind shield 607 helps shelter the burner portion 608 of the portable cooking system 600 (see FIG. 16). With reference to FIG. 16, the top edge 609 of the wind shield 607 is vertically above a bottom of the cooking vessel 604, while a bottom, opposite edge 611, of the wind shield 607 is vertically below the burner 608 and particularly the outlet orifices of the burner 608 where the flame exits the burner. In this configuration, the flux ring 613 is positioned entirely vertically between the top edge 609 and bottom edge 611. The wind shield 607 is generally an annular tubular member that is radially spaced outward from the remainder of the cooking vessel 604 forming an annular gap 615 radially between the cooking vessel 604, flux ring 613 and burner base 602. This annular gap 615 allows air flow between the wind shield 607 and remainder of the portable cooking system 600 illustrated by double headed arrow 617.

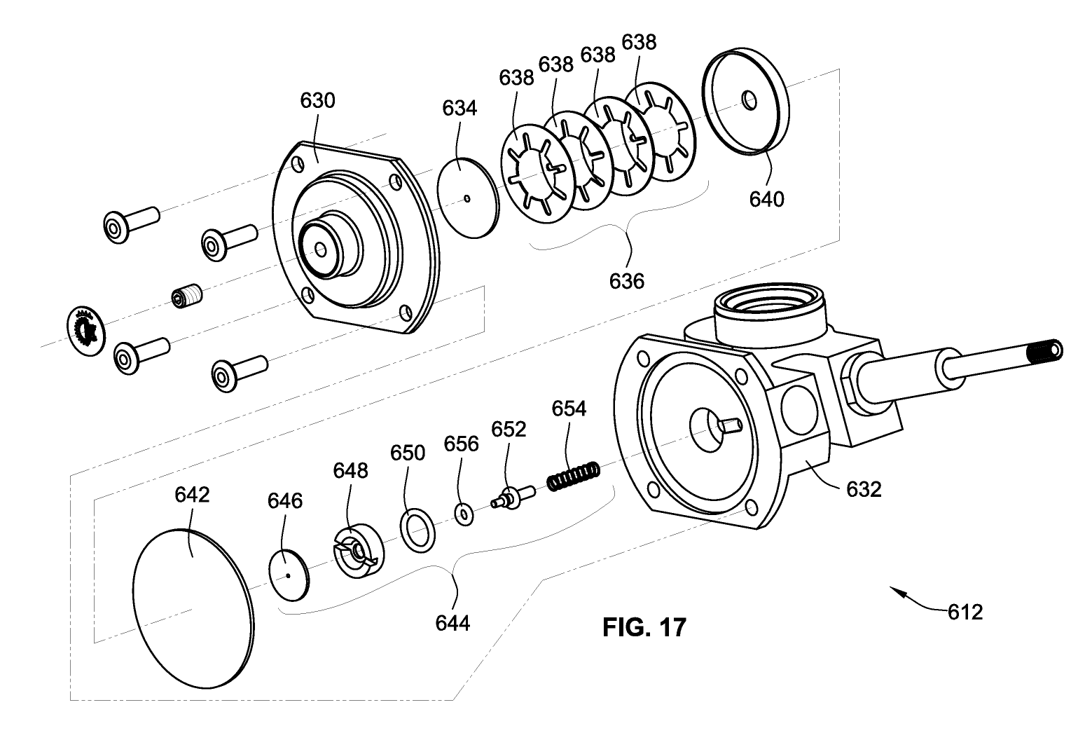

FIG. 17 is an exploded illustration of the valve/regulator assembly 612. The valve/regulator assembly 612 provides improvements over prior valve/regulator assemblies. It should be noted while the valve/regulator assembly 612 combines the valve and pressure regulator into a single module, these components could be separate in other embodiments.

The valve/regulator assembly 612 includes a regulator housing 630 that is secured to regulator body 632. The regulator housing 630 and regulator body 632 define an internal cavity that houses other fuel regulating components. The valve/regulator assembly 612 further includes a disc spring piston 634, a disc spring pack 636 that includes four separate disc springs 638. The disc spring piston 634 secures the disc spring pack 636 within a disc spring cup 640.

The disc springs 638 are generally conical. The disc springs 638 are grouped in pairs with two disc springs 638 aligned and interfitted with one another and two other disc springs aligned and interfitted with one another. The two sets of disc springs are then aligned in a back-to-back arrangement such that the sets of disc springs point axially away from one another. It has been found that this disc spring arrangement provides improved and/or more robust calibration of the portable cooking system.

The disc spring piston 634 has an axially extending portion 635 that extends axially into a central opening of the two axially outer disc springs 638.

A diaphragm 642 is secured within the internal cavity adjacent the disc spring cup 640.

A poppet assembly 644 is located on an opposite side of the diaphragm 642 as the disc spring piston 634, disc spring pack 636 and disc spring cup 640. The poppet assembly 644 includes a poppet hat 646, a poppet body 648, a poppet O-ring 650, a poppet stem 652, a poppet spring 654, and a poppet O-ring 656 carried on the poppet stem 652.

To improve reliability and durability of the system, the disc spring piston 634, the disc spring cup 640, poppet hat 646, poppet body 648, and poppet stem 652 are nickel-plated brass components. The nickel-plating, among other things, prevents corrosion of those components.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A portable cooking system comprising:
a regulator assembly;
a canister connection portion;
a burner; and
an evaporator feed tube operably connecting the regulator assembly with the burner, the evaporator feed tube including a heated section adjacent to the burner and that is heated by the burner when the burner is operational.

2. The portable cooking system of claim 1, wherein the evaporator feed tube further includes a filler positioned within the evaporator feed tube.

3. The portable cooking system of claim 1, wherein the regulator assembly includes:
a regulator housing that is secured to a regulator body defining an internal cavity therebetween;
a disc spring assembly including a disc spring pack including four disc springs each having a generally conical profile;
a diaphragm secured within the internal cavity adjacent the disc spring cup;
a poppet assembly located on an opposite side of the diaphragm as the disc spring piston.

4. The portable cooking system of claim 3, wherein the disc spring assembly further includes a disc spring piston and the poppet assembly includes: a poppet hat, a poppet body, a poppet stem; a poppet spring, and a poppet O-ring carried on the poppet stem.

5. The portable cooking system of claim 4, wherein the disc spring piston, the disc spring cup, poppet hat, poppet body, and poppet stem are nickel-plated brass.

6. The portable cooking system of claim 3, wherein the disc springs are grouped in pairs with two disc springs aligned and interfitted with one another and two other disc springs aligned and interfitted with one another, the two sets of disc springs being aligned in a back-to-back arrangement such that the sets of disc springs point axially away from one another.

7. The portable cooking system of claim 1, wherein the regulator assembly is configured to reduce the pressure of liquid fuel to approximately 10 psi above atmospheric pressure.

8. The portable cooking system of claim 1, further comprising a cooking vessel.

9. The portable cooking system of claim 8, further comprising an annular wind shield releasably mounted to and surrounding, at least in part, the cooking vessel, the annular wind shield having a top edge that is vertically above the burner and a bottom edge that is vertically below the burner.

10. The portable cooking system of claim 8, further comprising an annular wind shield releasably mounted to and surrounding, at least in part, the cooking vessel, the annular wind shield having a top edge that is vertically above the bottom of the cooking vessel and a bottom edge that is vertically below the bottom of the cooking vessel.

11. The portable cooking system of claim 1, wherein the canister connection portion faces the burner and is configured such that when a canister is mounted to the canister connection portion the canister is inverted with an outlet of the canister is vertically below a bottom wall of the canister.

12. The portable cooking system of claim 11, wherein the burner is positioned above the canister connection portion and spaced therefrom such that the canister may be positioned therebetween.

13. A portable cooking system configured to use a canister of fuel having an outlet through which fuel exits the canister, the canister having a bottom wall opposite the fuel exit, comprising:
a regulator assembly;
a canister connection portion;
a burner; and
an evaporator feed tube operably connecting the regulator assembly with the burner, the canister connection portion being configured such that when the canister is mounted to the canister connection portion the canister is inverted with the outlet of the canister vertically below the bottom wall.

14. The portable cooking system of claim 13, wherein the burner is positioned above the canister connection portion and spaced therefrom such that the canister may be positioned therebetween.

15. The portable cooking system of claim 13, wherein the evaporator feed tube includes a heated section adjacent to the burner and that is heated by the burner when the burner is operational.

16. The portable cooking system of claim 13, wherein the regulator assembly includes a diaphragm configured to reduce the pressure of liquid fuel to approximately 10 psi above atmospheric pressure.

17. The portable cooking system of claim 13, further comprising a cooking vessel.

18. A method of operating a portable cooking system comprising:
preheating a fuel prior to supplying the fuel to a burner of the portable cooking system by passing exhaust gases from the burner across an evaporator feed tube through which the fuel is supplied to the burner.

19. The method of claim 18, further comprising reducing the pressure of the fuel prior to preheating the fuel.

20. The method of claim 18, further comprising supplying the fuel from a canister oriented in an inverted orientation and then combusting the fuel at the burner.

21. The method of claim 20, wherein the burner is positioned vertically above the canister.

22. The method of claim 18, wherein the fuel is butane LPG.
